(19) United States
(12) Patent Application Publication
(10) Pub. No.: US 2007/0112136 A1
(43) Pub. Date: May 17, 2007

(54) Rubber composition and process for its production, process for production of vulcanized rubber composition molded articles, and vibration-proof material

(75) Inventors: Sadayuki Nakano, Ichihara-shi (JP); Akio Mase, Kasugai-shi (JP); Norihito Kimura, Kasugai-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED TOKAI RUBBER INDUSTRIES, LTD

(21) Appl. No.: 11/583,862

(22) Filed: Oct. 20, 2006

(30) Foreign Application Priority Data
Nov. 14, 2005 (JP) P2005-328447

(51) Int. Cl. C08F 8/00

(52) U.S. Cl. 525/191

(57) ABSTRACT

A rubber composition comprising the following component (A) 30-95 parts by weight, component (B) 5-70 parts by weight, component (C) 0.1-15 parts by weight and component (D) 0.01-15 parts by weight, and comprising no reinforcing filler (where the total of component (A) and component (B) is 100 parts by weight). (A) Ethylene-α-olefin-unconjugated diene copolymer rubber (B) Natural rubber (C) Organic peroxide (D) Aromatic amine

### BACKGROUND OF THE INVENTION

1. Field of the Invention

The present invention relates to a rubber composition and a process for its production, to a process for production of vulcanized rubber composition molded articles, and to a vibration-proof material.

2. Related Background Art

Many different types of vibration-proof rubber materials are used to prevent noise and vibrations in transportation means such as automobiles and motorcycles, as well as industrial machines, OA devices and household electrical appliances. Particularly in light of the increased engine performances and measures for exhaust gas regulations and noise regulations in the field of automobiles, demands are becoming stricter for vibration-proof rubber that can exhibit superior heat resistance and durability at high temperatures, as well as the ability to block noise and vibrations.

### SUMMARY OF THE INVENTION

Properties to be exhibited by such vibration-proof rubber include (1) excellent thermal aging resistance, (2) excellent durability against prolonged and repeated external force and (3) resistance to propagation of noise and vibrations and therefore low dynamic magnification (dynamic elastic modulus/static elastic modulus ratio).

In addition, it is of course important for the static rubber properties such as tensile strength and compression set to be at least equal to that of ordinary rubber.

Conventionally used vibration-proof rubber is high-unsaturated rubber such as natural rubber (NR) and styrene-butadiene copolymer rubber (SBR). This is because high-unsaturated rubber such as NR and SBR has the advantage of excellent durability and dynamic magnification compared to low-unsaturated rubber, but on the other hand such unsaturated rubber is known to have inferior thermal aging resistance compared to low-unsaturated rubber such as ethylene-α-olefin-unconjugated diene copolymer rubber, and therefore the use of high-unsaturated rubber has been limited to relatively low temperatures (see Japanese Unexamined Patent Publication HEI No. 3-227343). Conversely, low-unsaturated rubber such as ethylene-α-olefin-unconjugated diene copolymer rubber exhibits excellent thermal aging resistance but have the drawback of low durability against prolonged and repeated external force. Commonly known methods for improving the durability of ethylene-α-olefin-unconjugated diene copolymer rubber include (1) using higher molecular weight ethylene-α-olefin-unconjugated diene copolymer rubber, (2) increasing the ethylene content of the rubber and (3) strengthening the structure of the carbon black used in the rubber composition for improved reinforcement. Here, “strengthening the structure of the carbon black” means “using the bulky carbon black”.

The index of molecular weight in this case is generally Mooney viscosity (represented here as the measured value at ML₁₊₄, 125° C.), and for purposes requiring high durability there has been used high molecular weight ethylene-α-olefin-unconjugated diene copolymer rubber with a Mooney viscosity of 100 or greater. Compared to high-unsaturated rubber, however, the durability is still unsatisfactory.

High molecular weight ethylene-α-olefin-unconjugated diene copolymer rubber having a high ethylene content is also sometimes used. As a specific example of such rubber there may be mentioned rubber with an ethylene/α-olefin weight ratio of 85/15 or greater among the rubber components. However, when such ethylene-α-olefin-unconjugated diene copolymer rubber with a high ethylene content is added, the durability is improved but because the cold resistance of the rubber composition is severely impaired, the temperature dependency of the dynamic magnification is notably increased such that the vibration-proof performance at ordinary temperature is not exhibited during the winter season or in cold climates.

From the standpoint of the composition, it is well known that strengthening the structure of the carbon black used improves the durability, but because this also causes higher increase in the dynamic elastic modulus of the rubber composition than the increase in the static elastic modulus, the dynamic magnification is undesirably increased.

For carbon black, Japanese Unexamined Patent Publication HEI No. 3-227343 mentioned above discloses that a specific carbon black can be added to ethylene-propylene-diene copolymer rubber.

Also, Japanese Unexamined Patent Publication HEI No. 6-200096 describes a process for production of a vibration-proof material comprising a rubber composition obtained using at least 50 parts by weight of ethylene/propylene-based polymer, less than 50 parts by weight of natural rubber, “A” parts by weight of carbon black as a reinforcer where A is represented by the formula shown below, and a peroxide as a crosslinking agent.
A≦0.4X+30
Here, X is the amount of ethylene block propylene-based polymer, and the total of the ethylene/propylene-based polymer and natural rubber is 100 parts by weight. However, vibration-proof materials obtained by the aforementioned production process are problematic in that their durability at high temperature is insufficient.

It is an object of the present invention to provide a rubber composition with excellent thermal aging resistance and excellent durability at high temperature, as well as a process for its production, a process for production of vulcanized rubber composition molded articles, and a vibration-proof material. Here, the phrase “excellent durability at high temperature” means that the breaking elongation is large at high temperature under a constant load.

The present invention provides a rubber composition comprising the following component (A) 30-95 parts by weight, component (B) 5-70 parts by weight, component (C) 0.1-15 parts by weight and component (D) 0.01-15 parts by weight, and comprising no reinforcing filler (where the total of component (A) and component (B) is 100 parts by weight).
(A) Ethylene-α-olefin-unconjugated diene copolymer rubber
(B) Natural rubber
(C) Organic peroxide
(D) Aromatic amine

Vulcanization of a rubber composition having this constitution can yield a vulcanizate (rubber composition molded article) with sufficiently excellent thermal aging resistance and high-temperature durability. While the reason for this is not perfectly understood, it is believed that the vulcanizate exhibits excellent thermal aging resistance because the rubber composition of the invention comprises an aromatic amine. Also, it is believed that the vulcanizate exhibits excellent high-temperature durability because the rubber composition of the invention comprises the ethylene-α-olefin-unconjugated diene copolymer rubber, natural rubber and organic peroxide in the mixing proportions mentioned above.

Component (D) in the rubber composition of the invention is preferably an aromatic amine with 4 or more phenyl groups. Vulcanization of this type of rubber composition can yield a vulcanizate (rubber composition molded article) with even better thermal aging resistance.

The rubber composition described above can be obtained by a process for production of a rubber composition containing no reinforcing filler, which includes the following steps.
(1) A step of kneading at least component (A) 30-95 parts by weight of ethylene-α-olefin-unconjugated diene copolymer rubber, component (B) 5-70 parts by weight of natural rubber and component (D) 0.01-15 parts by weight of an aromatic amine, to obtain a kneaded blend.
(2) A step of mixing the kneaded blend with at least component (C) 0.1-15 parts by weight of an organic peroxide.
   The total of component (A) and component (B) is 100 parts by weight.

In this production process, component (D) is preferably an aromatic amine with 4 or more phenyl groups.

The present invention further provides a process for production of a vulcanized rubber composition molded article containing no reinforcing filler, which includes the following steps.
(1) A step of kneading at least component (A) 30-95 parts by weight of ethylene-α-olefin-unconjugated diene copolymer rubber, component (B) 5-70 parts by weight of natural rubber and component (D) 0.01-15 parts by weight of an aromatic amine, to obtain a kneaded blend.
(2) A step of mixing the kneaded blend with at least component (C) 0.1-15 parts by weight of an organic peroxide, to obtain a rubber composition.
(3) A step of heat molding the rubber composition to obtain a vulcanized rubber composition molded article.
   The total of component (A) and component (B) is 100 parts by weight.

The process for production of the rubber composition molded article can yield a vulcanizate (rubber composition molded article) with sufficiently excellent thermal aging resistance and high-temperature durability.

Component (D) for the production process is preferably an aromatic amine with 4 or more phenyl groups. This will yield a vulcanizate (rubber composition molded article) with even more excellent thermal aging resistance.

The invention still further provides a vibration-proof material composed of a vulcanized rubber composition molded article produced by the production process described above. Because the vibration-proof material comprises a rubber composition according to the invention, it exhibits sufficiently excellent thermal aging resistance and high-temperature durability.

### DESCRIPTION OF THE PREFERRED EMBODIMENTS

Component (A), the “ethylene-α-olefin-unconjugated diene copolymer rubber” is a copolymer of ethylene, an α-olefin and an unconjugated diene, where the α-olefin preferably has 3-20 carbon atoms and the unconjugated diene preferably has 3-20 carbon atoms. Examples of such α-olefins include propylene, 1-butene, 1-pentene, 1-hexene, 4-methyl-1-pentene, 1-octene and 1-decene. Preferred among these are propylene and 1-butene.

The unconjugated diene of component (A) may be used in combination with an unconjugated polyene such as an unconjugated triene. That is, component (A) may be an ethylene-α-olefin-unconjugated diene-unconjugated triene copolymer rubber. Examples of unconjugated dienes include linear unconjugated dienes such as 1,4-hexadiene, 1,6-octadiene, 2-methyl-1,5-hexadiene, 6-methyl-1,5-heptadiene and 7-methyl-1,6-octadiene; cyclic unconjugated dienes such as cyclohexadiene, dicyclopentadiene, methyltetraindene, 5-vinylnorbornane, 5-ethylidene-2-norbornane and 6-chloromethyl-5-isopropenyl-2-norbornane; and combinations of two or more thereof. Examples of unconjugated trienes include 2,3-diisopropylidene-5-norbornane, 2-ethylidene-3-isopropylidene-5-norbornane, 2-propenyl-2,2-norbornadiene, 1,3,7-octatriene, 1,4,9-decatriene, 5-vinyl-2-norbornane, 5-(2-propenyl)-2-norbornane, 5-(3-butenyl)-2-norbornane, 5-(4-pentenyl)-2-norbornane, 5-(5-hexenyl)-2-norbornane, 5-(5-heptenyl)-2-norbornane, 5-(7-octenyl)-2-norbornane, 5-methylene-2-norbornane, 6,10-dimethyl- 1,5,9-undecatriene, 5,9-dimethyl- 1,4,8-decatriene, 4-ethylidene-8-methyl- 1,7-nonadiene, 13 -ethyl-9-methyl-1,9,12-pentadecatriene, 5,9,13 -trimethyl- 1,4,8,12-tetradecadiene, 8,14,16-trimethyl-1,7,14-hexadecatriene, 4-ethylidene- 12-methyl-1,11-pentadecadiene, and combinations of two or more thereof. Preferred among these are 5-ethylidene-2-norbornane, dicyclopentadiene, and combinations of both.

The content of ethylene units in component (A) is preferably 40-80 wt % and more preferably 45-65 wt %, and the content of α-olefin units is preferably 20-60 wt % and more preferably 35-55 wt % (where the sum of the ethylene unit content and α-olefin unit content is 100 wt %). If the ethylene unit content exceeds 80 wt %, the cold resistance of the vulcanized rubber composition will be significantly impaired and the temperature dependency of the dynamic magnification will be notably increased, thereby, in many cases, preventing the ordinary temperature vibration-proof performance from being exhibited in winter season or cold climates. On the other hand, if the ethylene unit content is less than 40 wt %, the high-temperature durability of the vulcanized rubber composition may be impaired. The dynamic magnification is the change in the elastic modulus upon input of vibrations in the high-temperature wavenumber region (dynamic elastic modulus), and it is expressed as the ratio between the dynamic elastic modulus and the static elastic modulus. A lower dynamic magnification produces a superior vibration-proof property.

The Mooney viscosity (ML₁₊₄, 125° C.) of component (A) is preferably 50 or greater, and more preferably 80 or greater. If the Mooney viscosity is less than 50, the high-temperature durability of the vulcanized rubber composition may be impaired.

The content of unconjugated diene units in component (A) (or if the unconjugated diene is used in combination with an unconjugated polyene such as an unconjugated triene, the total content of both) is preferably 5-36, and more preferably 8-30, in terms of iodine number. If the iodine number is less than 5, the crosslinking density of the vulcanized rubber composition will be insufficient, often resulting in impaired high-temperature durability. If the iodine number is greater than 36, the dynamic magnification of the vulcanized rubber composition may be increased.

Examples for component (A) include ethylene-propylene-5-ethylidene-2-norbornane copolymer rubber and ethylene-propylene-dicyclopentadiene copolymer rubber. When component (A) is a combination of two or more copolymer rubber materials, the ethylene unit content, α-olefin unit content, Mooney viscosity and iodine number are evaluated for the combination as a whole. Component (A) may also be combined with an extender oil. Such a combination is known as “oil-extended rubber” by those in the field.

The process for production of component (A) is not particularly restricted, and the component may be produced by any publicly known process. Examples of polymerization catalysts to be used for production of component (A) include titanium-based catalysts, vanadium-based catalysts and metallocene-based catalysts.

The Mooney viscosity (ML₁₊₄, 100° C.) of the component (B) natural rubber used for the invention is preferably 20-180 and more preferably 30-170. If the Mooney viscosity is less than 20, the tensile strength of the vulcanized rubber composition may be impaired. If the Mooney viscosity is greater than 180, the kneading workability of the rubber composition may be impaired.

The amount of component (A) is 30-95 parts by weight and preferably 55-75 parts by weight, and the amount of component (B) is 5-70 parts by weight, and preferably 25-45 parts by weight (with a total of 100 parts by weight for both). If the amount of component (A) is less than 30 parts by weight, the heat resistance may be significantly impaired. If the amount of component (A) is greater than 95 parts by weight, the tensile strength of the vulcanized rubber composition molded article may be poor.

Examples for the component (C) organic peroxide used for the invention include dicumyl peroxide, 2,5-dimethyl-2,5-di(tert-butylperoxy)hexane, 2,5-dimethyl-2,5-di(benzoylperoxy)hexane, 2,5-dimethyl-2,5-(tert-butylperoxy)hexyne-3, di-tert-butyl peroxide, di-tert-butyl peroxide-3,3,5-trimethylcyclohexane and tert-butyl hydroperoxide. Particularly preferred among these are dicumyl peroxide, di-tert-butyl peroxide and di-tert-butyl peroxide-3,3,5-trimethylcyclohexane. From the viewpoint of improving the tensile strength of the vulcanized rubber composition, the content of component (C) may generally be 0.1-15 parts by weight and preferably 0.5-8 parts by weight, where 100 parts by weight is the total of components (A) and (B).

Component (D), the aromatic amine, used for the invention is preferably an aromatic amine with 4 or more phenyl groups. Examples for component (D) include N-phenyl-N′-isopropyl-p-phenylenediamine, N-phenyl-N′-(1,3-dimethylbutyl)-p-phenylenediamine, N-phenyl-N′-(3-methacryloyloxy-2-hydroxypropyl)-p-phenylenediamine, 2,2,4-trimethyl-1,2-dihydroquinoline polymer, 6-ethoxy-1,2-dihydro-2,2,4-trimethylquinoline, N-phenyl-1-naphthylamine, alkylated diphenylamine, octylated diphenylamine, 4,4′-bis(α,α-dimethylbenzyl)diphenylamine, p-(p-toluenesulfonylamide)diphenylamine, N,N′-di-2-naphthyl-p-phenylenediamine and N,N′-diphenyl-p-phenylenediamine. Particularly preferred among these are 4,4′-bis(α,α-dimethylbenzyl)diphenylamine, p-(p-toluenesulfonylamide)diphenylamine, N,N′-di-2-naphthyl-p-phenylenediamine and N,N′-diphenyl-p-phenylenediamine. The aromatic amine may be used alone or as a mixture of two or more different types. From the viewpoint of improving the thermal aging resistance, the content of component (D) may generally be 0.01-15 parts by weight and preferably 0.05-8 parts by weight, where 100 parts by weight is the total of components (A) and (B).

Since no reinforcing filler is used according to the invention, dynamic magnification of the vibration-proof material is low, or in other words the vibration-proof property is excellent.

Reinforcing fillers are listed in Handbook of Rubber/Plastic-Containing Chemicals” (issued by Rubber Digest), and they are compounding agents added to rubber to enhance the rubber vulcanizate properties (for example, hardness, tensile strength, modulus, impact resilience, and tear strength). Examples of reinforcing fillers include channel carbon blacks such as EPC, MPC and CC; furnace carbon blacks such as SAF, ISAF, HAF, MAF, FEF, SRF, GPF, APF, FF, CF, SCF and ECF; thermal carbon blacks such as FT and MT; acetylene carbon black; dry process silica; wet process silica; synthetic silicate-based silica; colloidal silica; basic magnesium carbonate; activated calcium carbonate; heavy calcium carbonate; light calcium carbonate; mica; magnesium silicate; aluminum silicate; high styrene resin; cyclized rubber, coumarone/indene resin; phenol/formaldehyde resin; vinyltoluene copolymer resin; lignin; aluminum hydroxide; and magnesium hydroxide.

The rubber composition of the invention may also contain additives. Specifically, it may contain compounding agents such as plasticizers, vulcanization accelerators, vulcanizing agents and vulcanizing coagents, resins such as polyethylene resin and polypropylene resin, or rubber materials other than components (A) and (B), such as styrene-butadiene rubber, chloroprene rubber, acrylonitrile-butadiene rubber, acryl rubber, butadiene rubber, liquid polybutadiene, modified liquid polybutadiene, liquid isoprene and modified liquid isoprene. The specific and preferred amounts of plasticizers, vulcanization accelerators, vulcanizing agents and vulcanizing coagents to be used are described below.

The rubber composition of the invention may be produced by a production process comprising the following steps (1) and (2).

Step (1) is a step of kneading components (A), (B) and (D) with an ordinary sealed kneading machine such as a Banbury mixer or a kneader.

Step (2) is a step of kneading together the kneaded blend obtained in step (1) with component (C) using an ordinary kneading machine such as a roll or kneader, preferably at below the decomposition temperature of component (C) (for example, below 100° C.), to obtain a rubber composition that can be vulcanized by heating. The rubber composition obtained by this step, in which component (C) undergoes virtually no decomposition, contains essentially the full amount of component (C) that is used.

Components (A), (B) and (D) used in step (1) and the kneaded blend and component (C) used in step (2) may each be combined with compounding agents such as plasticizers, vulcanization accelerators, vulcanizing agents and vulcanizing coagents, resins such as polyethylene resin and polypropylene resin, or rubber materials other than components (A) and (B), such as styrene-butadiene rubber, chloroprene rubber, acrylonitrile-butadiene rubber, acryl rubber, butadiene rubber, liquid polybutadiene, modified liquid polybutadiene, liquid isoprene and modified liquid isoprene.

Examples of plasticizers include plasticizers commonly used in the field of rubber, such as process oil, lubricating oil, paraffin, liquid paraffin, petroleum asphalt, vaseline, coal tar pitch, castor oil, linseed oil, factice, beeswax, ricinolic acid, palmitic acid, barium stearate, calcium stearate, zinc laurate and atactic polypropylene. Process oil is particularly preferred among these. The amount of plasticizer used will ordinarily be 1-150 parts by weight, and preferably 2-100 parts by weight, where 100 parts by weight is the total of components (A) and (B). By using a plasticizer in this range it is possible to obtain a rubber composition having the desired softness.

Examples of vulcanization accelerators include tetramethylthiurain disulfide, tetraethylthiuram disulfide, tetrabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sulfenamide, N-oxydiethylene-2-benzothiazole-sulfenamide, N,N-diisopropyl-2-benzothiazolesulfenamide, 2-mercaptobenzothiazole, 2-(2,4-dinitrophenyl)mercaptobenzothiazole, 2-(2,6-diethyl-4-morpholinothio)benzothiazole, dibenzothiazyl disulfide, diphenylguanidine, triphenylguanidine, diorthotolylguanidine, orthotolyl-bi-guanide, diphenylguanidine-phthalate, acetaldehyde-aniline reaction product, butylaldehyde-aniline condensate, hexamethylenetetramine, acetaldehydeammonia, 2-mercaptoimidazoline, thiocarbanilide, diethylthiourea, dibutylthiourea, trimethylthiourea, diorthotolylthiourea, zinc dimethyldithiocarbamate, zinc diethylthiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthogenate and ethylenethiourea. The amount of vulcanization accelerator used will ordinarily be 0.05-20 parts by weight and preferably 0.1-8 parts by weight, where 100 parts by weight is the total of components (A) and (B), from the standpoint of improving the tensile strength of the vulcanized rubber composition and inhibiting bloom generation.

Sulfur may be mentioned as an example of a vulcanizing agent. The amount of sulfur used will ordinarily by 0.05-5 parts by weight and preferably 0.1-3 parts by weight, where 100 parts by weight is the total of components (A) and (B), from the standpoint of improving the tensile strength of the vulcanized rubber composition and inhibiting bloom generation.

Examples of vulcanizing coagents include triallyl isocyanurate, N,N′-m-phenylenebismaleimide, methacrylic acid, methyl methacrylate, ethyl methacrylate, propyl methacrylate, isopropyl methacrylate, n-butyl methacrylate, i-butyl methacrylate, sec-butyl methacrylate, t-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethyleneglycol monomethacrylate, polypropyleneglycol monomethacrylate, 2-ethoxyethyl methacrylate, tetrahydrofurfuryl methacrylate, allyl methacrylate, glycidyl methacrylate, benzyl methacrylate, dimethylaminoethyl methacrylate, diethylaminoethyl methacrylate, methacryloxyethyl phosphate, 1,4-butanediol diacrylate, ethyleneglycol dimethacrylate, 1,3-butyleneglycol dimethacrylate, neopentylglycol dimethacrylate, 1,6-hexanediol dimethacrylate, diethyleneglycol dimethacrylate, triethyleneglycol dimethacrylate, polyethyleneglycol dimethacrylate, dipropyleneglycol dimethacrylate, polypropyleneglycol dimethacrylate, trimethylolethane trimethacrylate, trimethylolpropane trimethacrylate, allylglycidyl ether, N-methylolmethacrylamide, 2,2-bis(4-methacryloxypolyethoxyphenyl)propane, aluminum methacrylate, zinc methacrylate, calcium methacrylate, magnesium methacrylate and 3-chloro-2-hydroxypropyl methacrylate. From the viewpoint of improving the tensile strength of the vulcanized rubber composition, the amount of vulcanizing aid used will ordinarily be 0.05-15 parts by weight and preferably 0.1-8 parts by weight, where 100 parts by weight is the total of components (A) and (B).

Other examples of vulcanizing coagents include metal oxides such as magnesium oxide and zinc oxide. Zinc oxide is preferred among these. From the viewpoint of improving the tensile strength of the vulcanized rubber composition, the amount of vulcanizing aid used will ordinarily be 1-20 parts by weight, where 100 parts by weight is the total of components (A) and (B).

Step (3) is a step of heat molding the rubber composition obtained in step (2) with a molding machine such as a compression molding machine at a temperature of usually 120° C. or above and preferably 140° C.-220° C. for about 1-60 minutes, for decomposition of component (C) in the rubber composition to obtain a vulcanized rubber composition molded article.

Working of the vulcanized rubber composition molded article produces a vibration-proof material having a form suited for purposes such as engine mounts, muffler hangars and strut mounts.

### EXAMPLES

The present invention will now be explained by examples, with the understanding that the invention is not limited to the examples.

### Example 1

Step (1)

A kneaded blend was obtained by kneading 55 parts by weight of ethylene-propylene-5-ethylidene-2-norbornane copolymer rubber (trade name: ESPRENE 553 by Sumitomo Chemical Co., Ltd.) comprising 52 wt % ethylene units and 48 wt % propylene units (100 wt % as the total of both) and having a Mooney viscosity (ML₁₊₄, 125° C.) of 100 and an iodine number of 10 as component (A), 45 parts by weight of natural rubber with a Mooney viscosity (ML₁₊₄, 100° C.) of 65 as component (B), and 2 parts by weight of 4,4′-bis(α,α-dimethylbenzyl)diphenylamine (component (D-1)) as component (D), 5 parts by weight of zinc oxide of two different grades and 1 part by weight of stearic acid, with respect to 100 parts by weight as the total of components (A) and (B), using a 1700 ml Banbury mixer at a start temperature of 80° C., with a 60 rpm rotor speed for 5 minutes.

Step (2)

Next, the kneaded blend obtained in step (1) was mixed with 7 parts by weight of dicumyl peroxide (component (C)) and 0.3 part by weight of sulfur (vulcanizing agent) with respect to 100 parts by weight as the total of components (A) and (B) using an 8-inch open roll to obtain a rubber composition.

Step (3)

The rubber composition obtained in step (2) was pressed at 170° C. ×20 min and simultaneously molded and vulcanized to fabricate a vulcanized rubber composition molded sheet with a thickness of 2 mm. This sheet can be worked to produce a vibration-proof material having a shape suited for a specific purpose.

Evaluation of vulcanized rubber composition molded article

(1) High-Temperature Tensile Test

The breaking elongation of a dumbbell-shaped No.3 test piece of the fabricated sheet was measured according to JIS K 6251, using an AG-500E laser autograph (product of Shimadzu Corp.) with an ambient temperature of 120° C. and a pull rate of 500 mm/min. The results are shown in Table 1.

(2) Thermal Aging Resistance

A dumbbell-shaped No.3 test piece of the fabricated sheet (based on JIS K 6251) was heated at 150° C., 120 hr according to the normal oven method of JIS K 6257. Next, a QUICK READER P-57 (product of Ueshima Seisakusho Co., Ltd.) was used to measure the tensile strength, breaking elongation and hardness of the test piece at an ambient temperature of 23° C. and a pull rate of 500 mm/min, before and after heat treatment. The change in tensile strength before and after heat treatment (ΔTb), the change in breaking elongation before and after heat treatment (ΔEb) and the change in hardness before and after heat treatment (ΔHs) are shown in Table 1.

### Example 2

The same procedure was carried out as in Example 1, except for using 1.5 parts by weight of 4,4′-bis(α,α-dimethylbenzyl)diphenylamine (component (D-1)) and 0.5 part by weight of N,N′-di-2-naphthyl-p-phenylenediamine (component (D-2)) instead of 2 parts by weight of 4,4′-bis(α,α-dimethylbenzyl)diphenylamine (component (D-1)) as component (D) in step (1).

### Example 3

The same procedure was carried out as in Example 1, except for using 1 part by weight of 4,4′-bis(α,α-dimethylbenzyl)diphenylamine (component (D-1)) and 1 part by weight of N,N′-di-2-naphthyl-p-phenylenediamine (component (D-2)) instead of 2 parts by weight of 4,4′-bis(α,α-dimethylbenzyl)diphenylamine (component (D-1)) as component (D) in step (1). The results are shown in Table 1.

### Example 4

The same procedure was carried out as in Example 1, except for using 0.5 part by weight of 4,4′-bis(α,α-dimethylbenzyl)diphenylamine (component (D-1)) and 1.5 parts by weight of N,N′-di-2-naphthyl-p-phenylenediamine (component (D-2)) instead of 2 parts by weight of 4,4′-bis(α,α-dimethylbenzyl)diphenylamine (component (D-1)) as component (D) in step (1). The results are shown in Table 1.

### Example 5

The same procedure was carried out as in Example 1, except for using 2 parts by weight of N,N′-di-2-naphthyl-p-phenylenediamine (component (D-2)) instead of 2 parts by weight of 4,4′-bis(α,α-dimethylbenzyl)diphenylamine (component (D-1)) as component (D) in step (1). The results are shown in Table 1.

### Example 6

The same procedure was carried out as in Example 1, except for using 1.5 parts by weight of 4,4′-bis(α,α-dimethylbenzyl)diphenylamine (component (D-1)) and 0.5 part by weight of N-phenyl-N′-(3-methacryloyloxy-2-hydroxypropyl)-p-phenylenediamine (component (D-3)) instead of 2 parts by weight of 4,4′-bis(α,α-dimethylbenzyl)diphenylamine (component (D-1)) as component (D) in step (1). The results are shown in Table 2.

### Example 7

The same procedure was carried out as in Example 1, except for using 1 part by weight of 4,4′-bis(α,α-dimethylbenzyl)diphenylamine (component (D-1)) and 1 part by weight of N-phenyl-N′-(3-methacryloyloxy-2-hydroxypropyl)-p-phenylenediamine (component (D-3)) instead of 2 parts by weight of 4,4′-bis(α,α-dimethylbenzyl)diphenylamine (component (D-1)) as component (D) in step (1). The results are shown in Table 2.

### Example 8

The same procedure was carried out as in Example 1, except for using 0.5 part by weight of 4,4′-bis(α,α-dimethylbenzyl)diphenylamine (component (D-1)) and 1.5 parts by weight of N-phenyl-N′-(3-methacryloyloxy-2-hydroxypropyl)-p-phenylenediamine (component (D-3)) instead of 2 parts by weight of 4,4′-bis(α,α-dimethylbenzyl)diphenylamine (component (D-1)) as component (D) in step (1). The results are shown in Table 2.

### Example 9

The same procedure was carried out as in Example 1, except for using 2 parts by weight of octylated diphenylamine (component (D-4)) instead of 2 parts by weight of 4,4′-bis(α,α-dimethylbenzyl)diphenylamine (component (D-1)) as component (D) in step (1). The results are shown in Table 2.

### Comparative Example 1

The same procedure was carried out as in Example 1, except that no component (D) was used in step (1). The results are shown in Table 2.

TABLE 1

| | Exam- | | | | Exam- |
|---|---|---|---|---|---|
| | ple 1 | Example 2 | Example 3 | Example 4 | ple 5 |
| Component (A) | 55 | 55 | 55 | 55 | 55 |
| Component (B) | 45 | 45 | 45 | 45 | 45 |
| Component (C) | 7 | 7 | 7 | 7 | 7 |
| Component (D-1) | 2 | 1.5 | 1.0 | 0.5 | — |
| Component (D-2) | — | 0.5 | 1.0 | 1.5 | 2 |
| Component (D-3) | — | — | — | — | — |
| Component (D-4) | — | — | — | — | — |
| Evaluation | | | | | |
| Breaking | 170 | 175 | 200 | 230 | 225 |
| elongation (%) | | | | | |
| Thermal aging | | | | | |
| resistance | | | | | |
| ΔTb (%) | −19 | −24 | −21 | −29 | −28 |
| ΔEb (%) | −26 | −8 | −2 | −13 | −18 |
| ΔHs (Points) | +2 | −3 | −2 | −2 | ±0 |

TABLE 2

| | Exam- | Exam- | | Exam- | Comparative |
|---|---|---|---|---|---|
| | ple 6 | ple 7 | Example 8 | ple 9 | Example 1 |
| Component (A) | 55 | 55 | 55 | 55 | 55 |
| Component (B) | 45 | 45 | 45 | 45 | 45 |
| Component (C) | 7 | 7 | 7 | 7 | 7 |
| Component (D-1) | 1.5 | 1.0 | 0.5 | — | — |
| Component (D-2) | — | — | — | — | — |
| Component (D-3) | 0.5 | 1.0 | 1.5 | — | — |
| Component (D-4) | — | — | — | 2.0 | — |
| Evaluation | | | | | |
| Breaking | 170 | 180 | 170 | 185 | 170 |
| elongation (%) | | | | | |
| Thermal aging | | | | | |
| resistance | | | | | |
| ΔTb (%) | −8 | −16 | −38 | −39 | −35 |
| ΔEb (%) | −12 | −11 | −19 | −61 | −72 |
| ΔHs (Points) | ±0 | −1 | −2 | +11 | +25 |

The vulcanized rubber composition molded articles obtained in Examples 1-9 satisfying the conditions of the invention exhibit both satisfactory high-temperature breaking elongation and thermal aging resistance. However, the vulcanized rubber composition molded article obtained in Comparative Example 1 which contained no aromatic amine exhibited insufficient thermal aging resistance.

The present invention can provide a rubber composition with excellent thermal aging resistance and high-temperature durability, as well as a process for its production, a process for production of vulcanized rubber composition molded articles, and a vibration-proof material.

What is claimed is:

1. A rubber composition comprising the following component (A) 30-95 parts by weight, component (B) 5-70 parts by weight, component (C) 0.1-15 parts by weight and component (D) 0.01-15 parts by weight, and comprising no reinforcing filler (where the total of component (A) and component (B) is 100 parts by weight).
(A) Ethylene-α-olefin-unconjugated diene copolymer rubber
(B) Natural rubber
(C) Organic peroxide
(D) Aromatic amine

2. A rubber composition according to claim 1, wherein component (D) is an aromatic amine with 4 or more phenyl groups.

3. A process for production of a rubber composition comprising no reinforcing filler, which includes the following steps.
(1) A step of kneading at least component (A) 30-95 parts by weight of ethylene-α-olefin-unconjugated diene copolymer rubber, component (B) 5-70 parts by weight of natural rubber and component (D) 0.01-15 parts by weight of an aromatic amine, to obtain a kneaded blend (where the total of component (A) and component (B) is 100 parts by weight).
(2) A step of mixing said kneaded blend with at least component (C) 0.1-15 parts by weight of an organic peroxide.

4. A process for production of a rubber composition according to claim 3, wherein component (D) is an aromatic amine with 4 or more phenyl groups.

5. A process for production of a vulcanized rubber composition molded article containing no reinforcing filler, which includes the following steps.
(1) A step of kneading at least component (A) 30-95 parts by weight of ethylene-α-olefin-unconjugated diene copolymer rubber, component (B) 5-70 parts by weight of natural rubber and component (D) 0.01-15 parts by weight of an aromatic amine, to obtain a kneaded blend (where the total of component (A) and component (B) is 100 parts by weight).
(2) A step of mixing said kneaded blend with at least component (C) 0.1-15 parts by weight of an organic peroxide, to obtain a rubber composition.
(3) A step of heat molding said rubber composition to obtain a vulcanized rubber composition molded article.

6. A process for production of a vulcanized rubber composition molded article according to claim 5, wherein component (D) is an aromatic amine with 4 or more phenyl groups.

7. A vibration-proof material comprising a vulcanized rubber composition molded article obtained by the production process of claim 5.

8. A vibration-proof material comprising a vulcanized rubber composition molded article obtained by the production process of claim 6.
